(19) United States
(12) Patent Application Publication
(10) Pub. No.: US 2022/0020093 A1
(43) Pub. Date: Jan. 20, 2022

(54) A USER CONTROLLABLE FINANCIAL INVESTMENT SYSTEM AND A METHOD THEREOF

(71) Applicant: MAKALU AS, Oslo (NO)

(72) Inventor: Stein Schønning DYBVIK, Oslo (NO)

(73) Assignee: MAKALU AS, Oslo (NO)

(21) Appl. No.: 17/295,995

(22) PCT Filed: Nov. 15, 2019
(86) PCT No.: PCT/EP2019/081518

§ 371 Date: May 21, 2021

(30) Foreign Application Priority Data
Nov. 23, 2018 (EP) 18208085.3

(51) Int. Cl. G06Q 40/06; G06Q 40/04

(52) U.S. Cl. CPC G06Q 40/06; G06Q 40/04

(57) ABSTRACT

An automated user-controlled fund investment system and method that provides the ability of a user to control an investment strategy via an application program running in for example a smart phone. The client or application program running in the user's smart phone is communicating with a backend server system providing computer implemented management methods of the chosen strategy, and is providing different feedback information to the user of obtained results etc. The backend server system may be communicating with a stock exchange trading system, for example a trading robot. The combined backend server system and the trading system or trading robot makes up an example of a computerized fund management system according to the present invention.

### FIELD OF THE INVENTION

The present invention relates to a computer-based financial fund system comprising an application program running in a computer based mobile terminal enabling users to communicate with a backend server system controlling and executing user requests and commands and is configured to communicate with respective computer-based trading systems of respective stock and commodity exchanges.

### BACKGROUND OF THE INVENTION

The financial sector and especially the stock exchange market has been invaded by computerized solutions based on artificial intelligence and machine learning. One reason behind the development is the speed of trade provided by machines. When only humans were involved with trade on respective stock exchanges, a same specific share could be priced differently in New York compared with for example the stock exchange in Oslo. Smart traders could then by shares at a lower price at one stock exchange and sell them at a higher price on another stock exchange. The same situation could also be found with respect to commodity exchanges around the world.

One consequence of the technological development is that slow traders are losing in the market. Research of the computerized stock exchange markets indicates that the winners are the large commercial banks trading in large volumes using large amounts of money. The results indicate that the large commercial banks manage better when there are more robots than humans involved in the trading.

Access to such trading solutions for ordinary people is usually limited.

There are normally two types of investment products available for people with limited access to capital:
1) Active managed funds:
   In this setup, a talented fund manager invests the user's funds as he/she sees fit and is using for example expensive computer-based trading systems.
   However, this fund manager draws a fee from the investment that tends to be so large that it is difficult to achieve a positive return after fees are paid over time.
2) Index funds:
   In this setup, the fund invests automatically in assets included in an index according to the distribution in a market cap. This setup has lower costs and the returns are always the market average.

For both these investment products ordinary people has limited means for influencing the investment strategy other than investing and selling. In active managed funds, the fund manager(s) do all decisions, and in index funds, all decisions are calculated from the market cap distribution. Therefore, even a professional user can only decide to buy more or sell off some of the investment(s), and these actions often requires fees to be paid. Because of this, even professional users as well as ordinary people has limited possibility to react on events in society like political unrest or changing governments etc. and thereby exercise their influence in the capacity as owner of the assets. This fact will also create a distance between the user and the investment so that the user has little incentive for analyzing news and events and understanding how they will affect his/her investment in the future. When a fund is managed very well, i.e. the return of investments is regarded to be high, the amount of money that initially is invested must be above a certain level to avoid the pitfall wherein respective fund fees are eating up the return. Professional users usually have enough investment capital to avoid this pitfall. Ordinary people rarely have such a necessary amount of money to invest.

The present invention aims at providing a fund controlling computer system providing a simple interface and control providing any user simplified access means for changing an investment profile at any time, including for example increasing an already made investment in a specific industrial sector, in a specific country, in a specific company etc.

Especially, prior art lacks technical solutions enabling ordinary people to invest smaller amounts of money and at the same time enabling users to be active in deciding an investment profile as well as being able to react as owners to events influencing for example stock markets and thereby their investment.

Therefore, there is a need of a technical solution facilitating active investment and management of smaller amounts of money in funds.

### OBJECT OF THE INVENTION

It is a further object of the present invention to provide an alternative to the prior art.

In particular, it may be seen as an object of the present invention to provide an application program enabling users to control and define interactively as well as automatically investments in an index fund.

### SUMMARY OF THE INVENTION

Thus, the above-described object and several other objects are intended to be obtained in a first aspect of the invention by providing a computer implemented investment managing system enabling an user to define and control own investment profiles via an application program running in a mobile in communication with a backend server system, which is further in communication with a trading system.

The invention is particularly, but not exclusively, advantageous for obtaining an automated user-controlled fund investment system wherein respective users of the fund investment system has user defined fund investment profiles being recorded and updated in a back-end server system, wherein the investment system further comprises:
a mobile computer-based device configured with an investment system interface application,
the back-end server system in communication with the mobile computer-based device is configured to respond to user interactions provided via the investment system interface application,
a trading server system in communication with the back-end server system is configured to execute trading orders associated with responses of the back-end server system responding to respective user interactions from the investment system interface application,
wherein the bac-end server system further is configured to receive network communicated notifications related to results of trading orders from the trading server system, and
at a selected time, t, the back-end server system is configured to rebalancing the fund and update associated results in respective user profiles and reporting results to respective investment system interface applications of respective mobile computer-based devices.

Further, the invention comprises a computer implemented method of user-controlled investments in a fund controlled by an automated fund investment system according to claim 1, wherein the fund is investing in assets groups comprising geographical regions, and/or countries, and our industrial sectors, wherein the computer implemented method comprises steps of:
deciding by a user an amount to invest in the fund,
activating a payment solution transferring the amount to an investment account in the user's name in the investment system,
calculating an estimated percentage of the total fund owned by the user after the transfer of the amount,
using the estimated percentage of the total fund of the user together with the percentage of each other user in the fund, and update the estimated percentage accordingly,
waiting until results of any trading with the respective user-amounts is finished, and rebalancing the fund,
calculating respective user's actual percentage of the fund based on the result of the trading and the rebalancing of the fund.

Respective aspects of the present invention may each be combined with any of the other aspects. These and other aspects of the invention will be disclosed and elucidated with reference to the embodiments described herein.

### DESCRIPTION OF THE FIGURES

FIG. 1 illustrates an example of embodiment of the present invention.

FIG. 2 illustrates further aspects of the example of embodiment in FIG. 1.

FIG. 3 illustrates further aspects of the example of embodiment in FIG. 1.

FIG. 4 illustrates further aspects of the example of embodiment in FIG. 1.

FIG. 5 illustrates an example of a graphical user interface according to the example of embodiment of FIG. 1.

FIG. 6 illustrates further aspect of a graphical user interface according to the example of embodiment of FIG. 1.

FIG. 7 illustrates further aspect of a graphical user interface according to the example of embodiment of FIG. 1.

FIG. 8 illustrates further aspect of a graphical user interface according to the example of embodiment of FIG. 1.

FIG. 9 illustrates further aspect of a graphical user interface according to the example of embodiment of FIG. 1.

FIG. 10 illustrates a graph of obtained results of the example of embodiment of FIG. 1.

FIG. 11 illustrates examples of steps of a method of the present invention.

FIG. 12 illustrates examples of steps of a method of the present invention.

FIG. 13 illustrates examples of steps of a method of the present invention.

FIG. 14 illustrates further aspect of the example of embodiment illustrated in FIG. 1.

### DETAILED DESCRIPTION OF AN EMBODIMENT

Although the present invention is disclosed in connection with specific examples of embodiments, it should not be construed as being in any way limited to the presented examples. The accompanying claim set defines the scope of protection of the present invention. In the context of the claims, the terms “comprising” or “comprises” do not exclude other possible elements or steps. Further, the mentioning of references such as “a” or “an” etc. should not be construed as excluding a plurality. The use of reference signs in the claims with respect to elements indicated in the figures shall also not be construed as limiting the scope of the invention. Furthermore, combining individual features mentioned in different claims may possibly be advantageously, and the mentioning of these features in different claims does not exclude that a combination of features is not possible and advantageous.

An aspect of the present invention is the ability of a user to control an investment strategy via an application program running in for example a smart phone or similar computer based mobile device. The client or application program running in the user's smart phone is in communication with a backend server system configured to provide computer-controlled management and execution of the chosen strategy, and is further configured to provide different feedback information to the respective users of obtained results etc.

Further, the backend server system is integrated, or is in communication, with a stock exchange trading system, for example a trading robot. The combination of the application running in for example a smart phone, the backend server system and the trading system or trading robot makes up an example of a configured computerized fund management system according to the present invention.

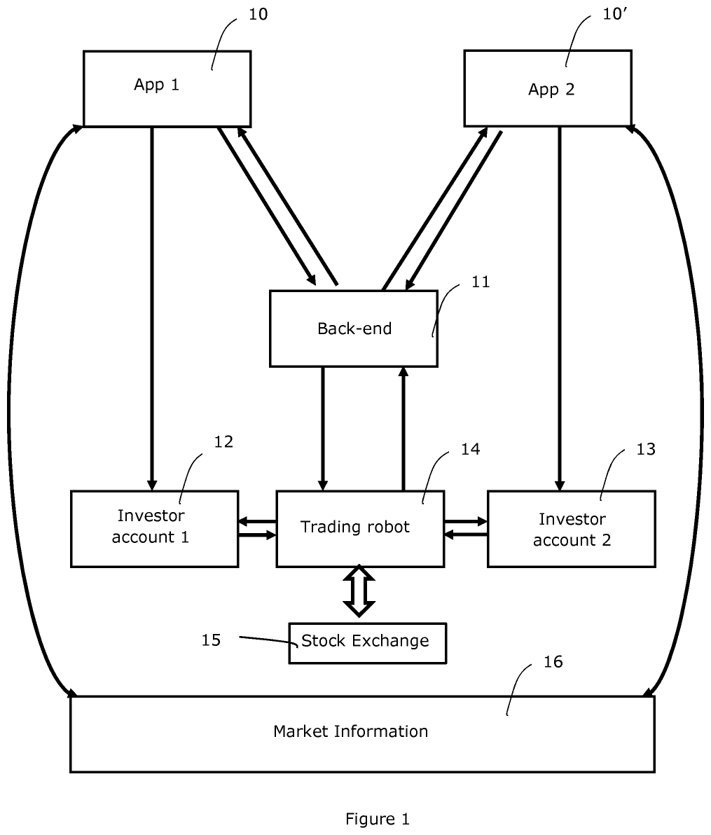

FIG. 1 illustrates an example of embodiment of the present invention. At least a first mobile phone 10 operated by a first user, and at least a second mobile phone 10′ operated by a second user is utilizing a respective downloaded application program according to the present invention being configured to communicate with a backend system 11. The backend system 11 is configured to manage investments ordered by respective users. The first user has an investment account 12, and the second user has an investment account 13. The backend system is configured to be in communication with a computer-based trading system 14 configured to buy and sell shares or assets of different types, for example shares bought and sold on respective stock exchanges, and assets bought and sold on commodity exchanges, for example.

There are different investment strategies available. One common advice is of course not to put “all your eggs in one basket”. Diversified investments are a strategic choice. This aspect is taken care of when for example an embodiment of the present system is managing an index fund, which by default is a diversified investment. The investment done by the user is buying a share of the index fund, i.e. not initially buying specific shares. Which specific shares and commodities that is bought and sold is a decision made for example by a trading robot 14, under guidance by the configured backend server system 11.

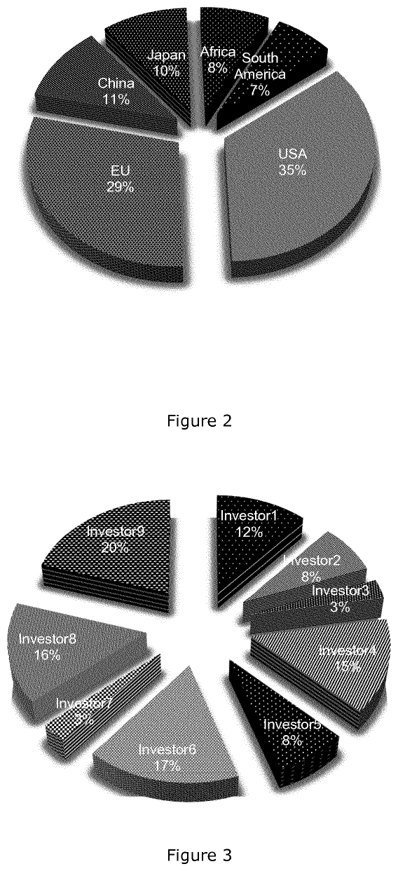

As an example, an index fund is used, and an index fund will invest in asset types that can be grouped based on specific parameter(s). In the following example, geographical regions are used, but this could also be sectors and/or investment product types. As all index funds, this product has two sides of the balance. The asset side is comprised of the various investment assets in a distribution that will combine all the respective user's portfolio setups, and the liability side is comprised of all the respective user's share of the index funds value. Using regional groups is illustrated in FIG. 2. In the example, the index fund has invested 35% of the total index fund in USA, 29% in EU, etc.

When users buy into the index fund, money is transferred from the users account into the account of the index fund. When this is done, the backend system 11 is configured to assign (calculate) a percentage of the index fund associated with the investment account 12, 13. FIG. 3 illustrates an example of possible percentage respective users 1 to 9 has at a same current point in time t. When users sell parts of what they own of the index fund, or invest more money into the index fund, the respective percentage of the index fund needs to be re-assigned. The backend system 11 is configured to re-balance user values. The backend system 11 can be configured to re-balance respective user's values at any time, even in real-time. However, if the re-balancing happens too often, i.e. at a higher frequency, the operating cost of the fund increases. Use of official exchange prices, which is the end-of-day pricing of the exchanges, is the least expensive prices and is therefore a preferred time for re-balancing the fund.

More details are provided below.

The value of the index fund is based on the value of respective assets in the markets owned by the index fund in different groups, for example geographical areas.

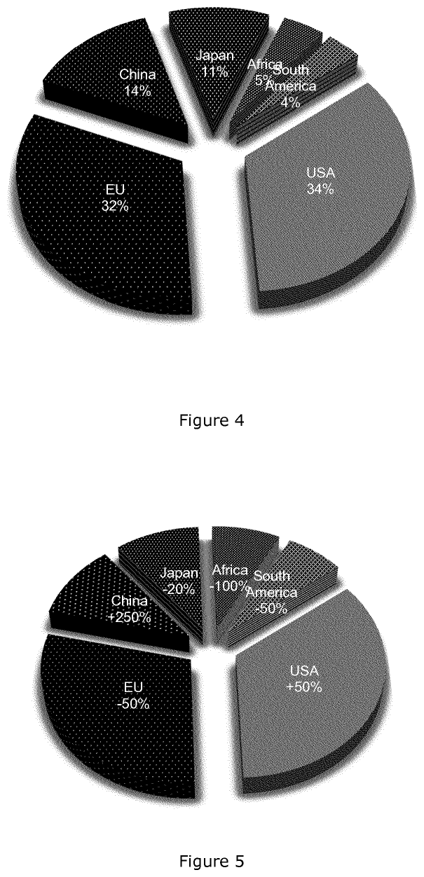

FIG. 4 illustrates an example wherein the index fund's value is diversified with a percentage in each group. For example, USA with 34%, EU with 32% etc. The natural size of the respective assets is set as a percentage of the total market value.

The exposure of invested money to respective groups is normally a responsibility of managers of the index fund. According to an aspect of the present invention, users can actively participate in the management of their own investment. Each user can change the exposure against each of the various asset groups (thereby defining their own investment strategy). The input is given as a custom weight for each group, enabling each user to change their exposure as follows: 0% (default) equals no input (e.g. follow the «natural weighting» of the group (as defined above). Otherwise the users can select any weighting between removal of all investments from the group (−100%) and the assigned top exposure level (+X%) (+100% will imply doubling of the «natural weighting»).

An example of changing exposure by a user input is illustrated in FIG. 5. EU is reduced with 50%, USA with 50%, while China is increased with 250%, etc. With reference to FIG. 1, the application program is configured to communicate with information sources 16 providing market information. The information may be communicated to the mobile phone of respective users on a regular basis, or the user is contacting an information source via a WEB browser, for example. Based on this information, or other types of information, like bad weather, etc. the user can change his exposure in real time. Further details are provided below.

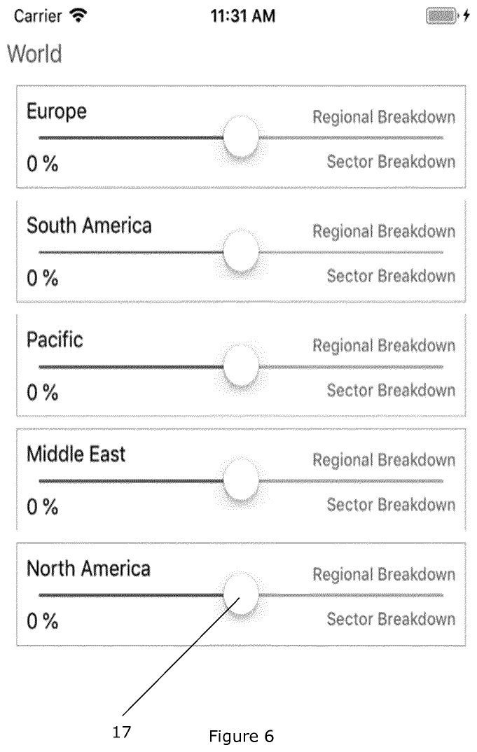

FIG. 6 illustrates a graphical user interface of an interface application program according to the present invention. The defined grouping of the index fund is in this example a geographical grouping of different geographical areas like Europa, USA, South America etc.

With reference to the description of FIGS. 5 and 6, FIG. 7 illustrates how an user can change the exposure to Europe by increasing the exposure with 50%, while USA is reduces by −38% just by touching and moving a type of computer modelled image of a potentiometer associated with each group, i.e. each geographical region. The user can move the computer software modelled button 17 for example to the right thereby increasing the exposure to the group associated with the specific button 17.

When moving to the left the exposure may for example be decreased. When this is done, i.e. changes of the exposure is done, the interface application program is configured to communicate the changes to the backend system 11, which does the necessary recalculations of respective values of respective users and instructing the trading system (or trading robot) 14 to execute the changes. This is done according to the selected re-balancing frequency.

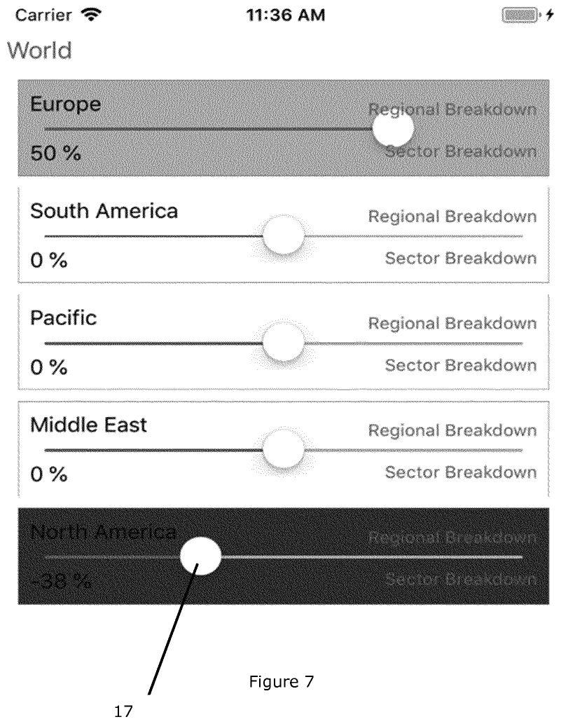

FIG. 7 illustrates some interactive touch activating fields on the display of a mobile phone executing an example of interface application program according to the present invention. A first touch activating field is denoted “Regional breakdown”. When an user touches this field, the interface application program is configured to display for example different countries of a region associated with the specific activation field.

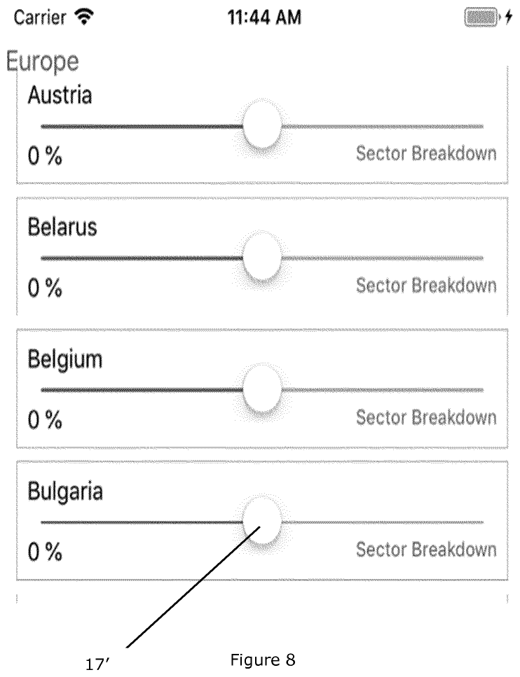

FIG. 8 illustrates a break down to some European countries like for example Austria, Belarus, Belgium and Bulgaria. Each country is associated with a computer modelled potentiometer as discussed above. By moving the associated potentiometer button 17′, the exposure to different countries can be changed. When this is done, i.e. changes of the exposure is done, the interface application program is configured to communicate the changes to the backend system 11, which does the necessary recalculations of respective values of respective users and is instructing the trading system (or trading robot) 14 to execute the changes.

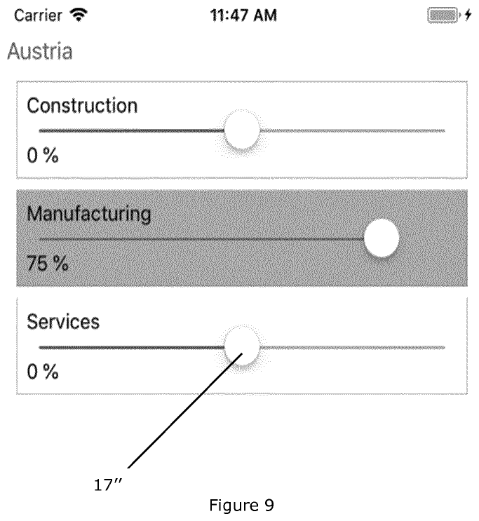

A user interface of an example of interface application program according to the present invention can also comprise a touch activating field section on the display denoted “Sector breakdown”. For example, if the “Sector break down” field associated with Austria is touched (refer FIG. 7), a display like the one illustrated in FIG. 9 will appear. Three examples of sectors are displayed “Construction”, Manufacturing” and “Services”. By moving the associated potentiometer button 17′, the exposure to different sectors can be changed. When this is done, i.e. changes of the exposure is done, the interface application program is configured to communicate the changes to the backend system 11, which does the necessary recalculations of respective values of respective users and is instructing the trading system (or trading robot) 14 to execute the changes. This aspect of the present invention gives small users the ability actively to influence the prices in the market. If the prices goes down, the larger users will certainly react. Especially, trading robots are sensitive to such changes.

Generally, the example of a graphical user interface according to the present invention comprises at least one interactive touch sensitive display field associated with an asset group, wherein the at least one touch sensitive display field comprise a further touch sensitive subfield, and

when the touch sensitive subfield is activated, the fund managing interface is configured to break down the touch sensitive field associated with the asset group into a plurality of further touchable subfields associated with respective sub categories in of the asset group enabling a user to increase or decrease a percentage of exposure to respective sub categories.

Respective subfields associated with respective sub categories may comprise further touch sensitive display fields, wherein when a further touch sensitive display field is activated, the fund managing interface is configured to break down a sub category into respective further sub categories.

The selection of geographical areas, countries, business sectors etc. is related to strategic choices based on knowledge of the respective investment areas. Such knowledge is of course sometimes based on guessing a business development that can influence the stock exchange market. The interface application program according to the present invention has the ability to guide an user by communicating with different information sources like market analysis, news archives etc. enabling the user to decide an investment in specific geographical areas and/or business areas. FIG. 1 illustrate how a mobile phone 10, 10′ can communicate with such information sources.

One important aspect of the present invention is that the system is capable of tracking investments of the total index fund, but also by tracking the individual investments of respective users in real time. An user will therefore have a real time feedback of how the investment and his strategy perform. If the user sees that his prediction fails, the user has the possibility to intervene and change his investment strategy at any time, i.e. change a percentage of his investment in a geographical area and/or business area for example.

The feedback provided by the system is educational in itself. Over time, users will learn better to assess for example the impact of political changes in the world etc.

Another aspect of the present invention is the ability that a specific user can compare his own performance with another user's performance. One aim is to learn if the strategy selected is better than another user's investment strategy, or is worse, or is the same.

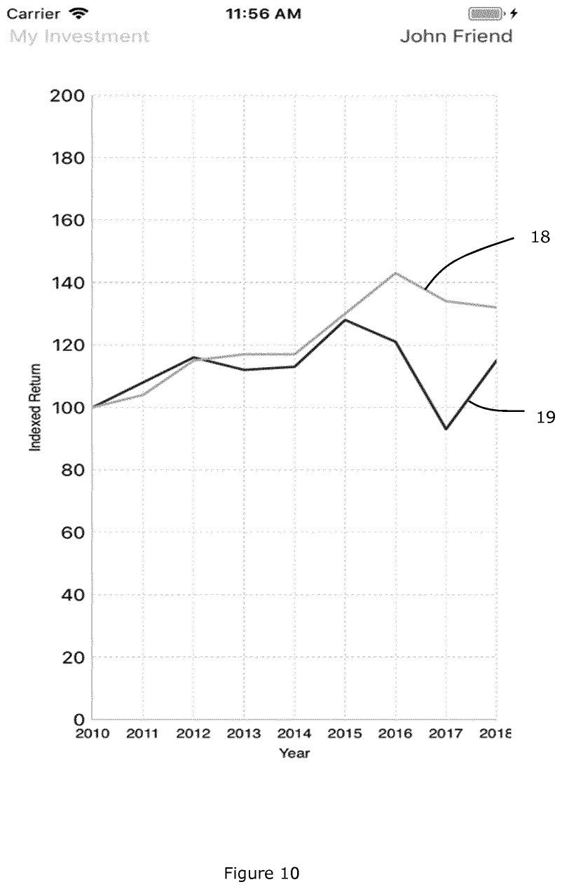

FIG. 10 illustrates a performance graph illustrating how first user 18 performs compared to second user 19. The indexed return is given as a percentage of initial investment of respective user. The graph illustrates the changes over years, but any timescale can be used.

According to an aspect of the present invention, a first user may be allowed to follow investment performance of a second user, for example via graphs as illustrated in FIG. 10

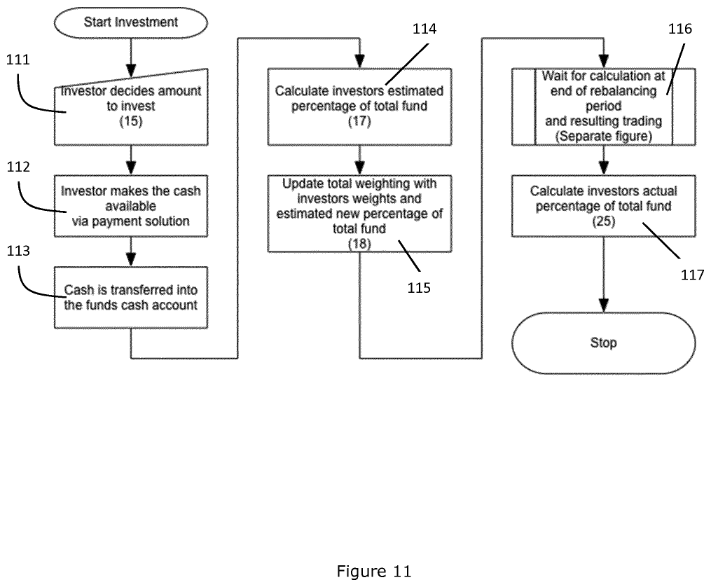

FIG. 11 illustrates a typical sequence of steps when an user decides to invest. The user has initially downloaded a copy of an example of embodiment of the interface application program according to the present invention.

When executed the first time, the interface application program may start inquiring the user about name, address, e-mail address, phone numbers, social security number etc. In addition, information about a bank account is recorded which the interface application program can configure to collect money from when investing in the index fund. Any money from sales of assets handled by the index fund can be deposited on this account as well.

The payment system can be according to any known payment system like for example Paypal. When the initial information is recorded, the interface application program transmit a notification to the backend system 11 illustrated in FIG. 1. In addition, a user account 12, 13 is generated by the backend system 11 based on the information about the user received from the associated mobile phone. From this account 12, 13 money can be drawn by the trading system 14 when authorized by the backend system 11. The backend system 11 receives the authorization from the mobile phone 10, 10′ associated with the user's name, which is associated with the associated investment account 12, 13.

Via a user interface (not illustrated) the user decides the amount to invest in the index fund. In FIG. 11, step 111 illustrate this step. The user activates the payment solution 112, for example Paypal, by logging into the account of the payment system. The amount is then withdrawn from a bank account at the user's disposal. As disclosed above, the information entered by the user regarding name, address social security number etc. is then used to create the investment account associated with the user. The money transferred via the payment system is then allocated 113 to the created investment account 12, 13.

The next step 114 is done by the backend system 11 calculating the estimated percentage of the total index fund. It is important to understand that at this moment no actual purchase of assets is done. Therefore, the actual percentage is just an estimate at this point. In step 115, total weights are updated including respective user choices as discussed with reference to FIG. 6, FIG. 7, FIG. 8 and FIG. 9. A new estimated percentage of the index fund is calculated. The backend system is configured to instruct the trading system 14 to execute an investment according to the investment strategy defined by the updated weights of each group.

The next step 116 is to wait for the trade to be finished and reported by the trading system 14. At this stage the backend system is configured to calculate the user's actual percentage of the index fund in step 117.

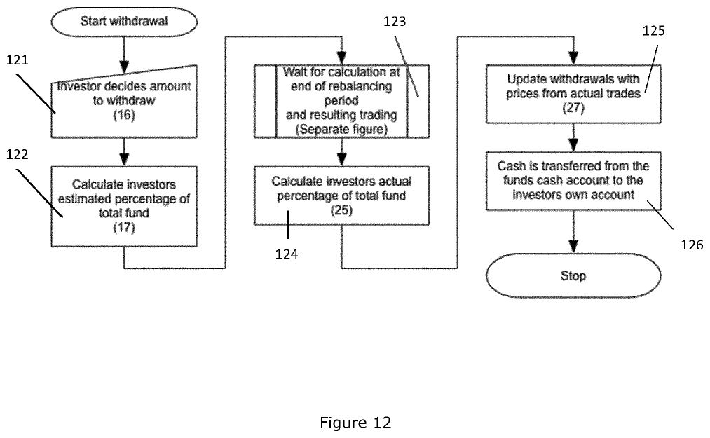

FIG. 12 illustrates steps of a process of withdrawal of funds from the index fund. In step 121 the user decides the amount to withdraw from the index fund. For example, the interface application program can be configured to receive a number that is a percentage, for example 10%, of the assets to be sold. It can also be a fixed monetary number, for example $1000. Before withdrawal, the estimated percentage the user owns of the index fund is calculated 122. This is necessary to do since the market is changing all the time. The calculation is done after rebalancing of the index fund and resulting trading 123. Then in step 124, the actual percentage of the total fund is calculated. The withdrawals are updated with prices from actual trades 125. In step 126 cash is transferred to the account associated with the user.

Both the process of buying and selling is related to a specific moment in time t, which implies a value of the index fund at time t. i.e. actual prices of transactions at time t.

Over time the prices of all assets in the fund will vary. Some will increase and some will fall. This changes the percentage of the total market cap for each individual asset. The process of realigning the distribution of assets owned by the fund with the distribution of market cap in based on new prices is called rebalancing. For the type of fund described here, new user input will also be included in this process, whether that is deposits into the fund, withdrawals from the funds, or changed weighting for the user investments.

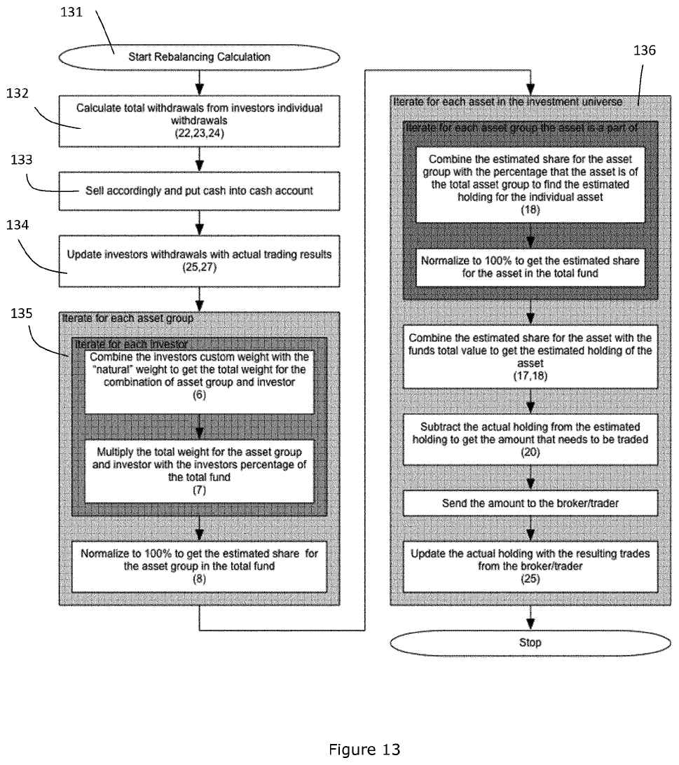

The rebalancing can be a process run regularly, or as a result of trades that needs to be accounted for in real time. FIG. 13 illustrates a process of rebalancing of the index fund. As discussed above, different frequencies of re-balancing the fund influence the cost of the fund. In normal circumstances, the re-balancing happened when respective stock exchanges publish their end-of-day pricing.

With respect to FIG. 2, different stock markets are assigned to the fund. It is obvious that a stock exchange in USA has a closing time different from a closing time of e European stock exchange. Therefore, when referring to a frequency, it is not a single frequency, but a frequency assigned to each respective stock exchange the fund is using. However, to simplify the matter, the rebalancing may happen when the last stock exchange of all the actual stock exchanges is closing for the day. Then all end-of-day prices are available.

In step 131 the rebalancing starts at time t followed by a step 132 comprising a calculation of total withdrawals from a user's withdrawals up to time t from previous time the rebalancing was performed. In step 133 the withdrawals are converted into instructions from the backend system 11 to the trading system 14 of selling assets according to the submitted instructions. Cash from the transactions are transferred to the respective users account via the payment system. In step 134 actual trading results are used to update a user's actual withdrawals.

In step 135 there is performed two interlinked iterative processes. One iterative process is related to the different assets groups as discussed with reference to FIG. 6, FIG. 7, FIG. 8 and FIG. 9. When a first group is investigated in the iterative process, a sub-iteration is performed for each user with respect to what the user has of assets in the first group. When the iteration of all users with respect to assets in the first group is completed, a second group is processed wherein all users assets of the second group is evaluated as for the first group. As discussed above, the custom weights are combined with natural weights to obtain the total weight for the combination of asset group and user. The total weight for the asset group and the user is then multiplied with percentage of the total fund. The result is normalized to 100% thereby the estimated share of the asset group of the total index fund is found.

The next step 136 is an iteration for each asset in the index fund that is invested. However, this must be done in a further iterative process wherein each group the asset is part of is iterated.

Details of respective calculations is disclosed in the section below “Mathematical background”.

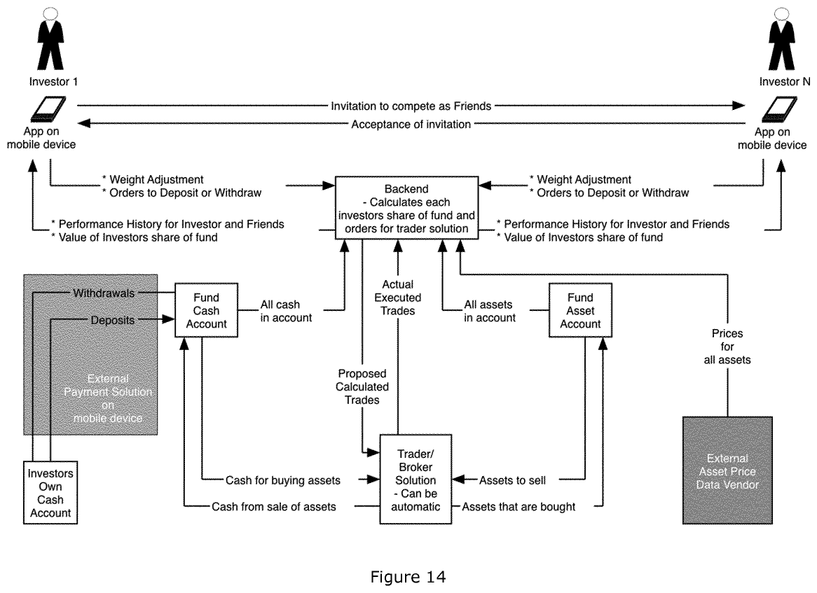

FIG. 14 disclose further details of an example of system disclosed in FIG. 1. The information flow discussed with respect to the flow diagrams of FIG. 11, FIG. 12, and FIG. 13 is illustrated in FIG. 14.

Another aspect of the interface application program or client program according to the present invention is that an API (Application Program Interface) providing a simple script language is part of the interface application program. The user can use the API to create his own “trading robot”. By following for example a performance indicator of his investments, the script language can instruct the system to change investment strategy, for example redistribution of investments in respective geographical areas and/or change of business area, or a change from shares to commodities etc.

Here follows some non-limiting examples of scripts:

### EXAMPLE 1

If Performance-indicator-change ≤5%, then

Decrease Europe 3% and Increase USA 3%, or

If Performance-indicator-change ≥5%, then

Transfer 1000$ to investment account, else

Wait one week and repeat.

### EXAMPLE 2

If Performance-indicator-change ≤5%, then

Decrease Europe 3% and Increase USA 3%, or

If Performance-indicator-change ≥5%, then

Transfer 1000$ to investment account, else

Repeat.

### EXAMPLE 3

If Performance-indicator-change ≤5%, then

Decrease Europe 3% and Increase USA 3%, or

If Performance-indicator-change ≥5%, then

Transfer 1000$ to investment account, else

Repeat until Performance-indicator-change ≥3%, or

Terminate if Performance-indicator-change ≤2%.

The present invention is a novel system and method enabling ordinary people to invest actively smaller amount of money in shares and/or commodities. Prior art solutions are expensive excluding ordinary people from investing in funds. An aspect of the present invention is that a of smaller number of users can influence pricing of assets in the market. Further, the system and method of the present invention requires little knowledge beforehand for people willing to try embodiments of the present invention.

Mathematical Background:

Definitions:

User (i)—a specific user that owns assets in the fund

Asset(a)—a specific asset that the fund has invested in

Time (t)—a specific day

Previous day (t−1)—the day before t

Deposit (dep)—the value of a deposit an user(i) makes to the index fund at any given time(t):

dep(i,t)

Withdrawal (wdr)—the value of a withdrawal a user(i) makes from the index fund at any given time(t):

wdr(i,t)

Investment (I)—the amount each user(i) owns in the index fund at any given time (t):

I(i,t)

Total number of users (m) in the index fund at any given time(t):

m(t)

Total number of distinct assets (n) in the index fund at any given time(t):

n(t)

Weighting group (g)—all assets(a) will belong to one ore more weighting groups (g) at any given time(t):

g(a,t)

Amount owned (o)—the number of each specific asset(a) that the index fund owns at any given time(t):

o(a,t)

Price (p)—the market price that each instrument provides at a given time(t)

p(a,t)

Market cap (mc)—the value that all issues of a given asset(a) have in the market at a given time(t)

mc(a,t) (1)

Return (r)—the change in market price defines the return of each asset(a) at a given time(t) since the previous time(t−1):

$$r ( a , t ) = \frac{p ( a , t ) - p ( a , t - 1 )}{p ( a , t - 1 )} \qquad ( 2 )$$

Value (v)—the index funds holdings of a specific asset(a) can be calculated at any given time(t):

v(a,t)=o(a,t)*p(a,t) (3)

Total value (TV)—the total value of the index fund can be calculated at any given time(t):

$$TV ( t ) = {\sum }_{a = 1}^{n ( t )} v ( a , t ) \qquad ( 4 )$$

Natural weight (nw)—the market cap of a specific asset(a) as a percentage of the combined total market cap of all assets included in the index funds investment universe:

$$nw ( a , t ) \text{?} = \frac{mc ( a , t ) \text{?}}{{\sum }_{a = 1}^{n ( t )} mc ( a , t )} \\ \text{?} \text{indicates text missing or illegible when filed} \qquad ( 5 )$$

Custom weight (cw)—the custom weight that the user(i) have selected for a weighting group (g) is valid for all asset(a) in the weighting group at any given time(t):

cw((t,a,t)−cw(t,g(a,t),t) (6)

Combined weight (W)−the combined weight is calculated from the natural weight(nw) and the custom weight(cw) for each user(i) and asset(a) at any given time(t):

$$W ( t , a , t ) = nw ( a , t ) \text{?} * \frac{cw ( i , a , t ) \text{?} + 100}{100} \\ \text{?} \text{indicates text missing or illegible when filed} \qquad ( 7 )$$

User return(R)—based on the combined weight(W), each user(i) will have a weighted return for the investment:

$$R ( t , t ) = {\sum }_{a = 1}^{n ( t )} ( W ( t , a , t - 1 ) * r ( a , t ) ) \qquad ( 8 )$$

Percentage (P)—based on the users' returns(R) and percentage(P) at an earlier time (t−1), the percentage of the index fund can be calculated at any given time(t):

$$P ( t , t ) = \frac{P ( t , t - 1 ) * R ( t , t )}{{\sum }_{t = 1}^{m ( t )} ( P ( t , t - 1 ) * R ( t , t ) )} \qquad ( 9 )$$

Users Value (IV)—the value of each users(i) investment at any given time (t):

IV(i,t)=P(i,t)*TV(t) (10)

Real Time Rebalancing

At any time(t) all user values must undergo a re-calculation and the index funds holdings of assets are adjusted to mirror the combination weights of the users combined. This starts with the same values at the previous time(t−1) and adjusts for all the changes at time(t):

Before the maintenance the index fund will have a total value and distribution of assets, based on the values of the instruments the index fund actually holds:

$$TV ( t - 1 ) = {\sum }_{a = 1}^{n ( t - 1 )} v ( a , t - 1 ) \qquad ( 11 )$$

Each user(i) will have an user value at the previous time(t−1):

IV(i,t−1)

Each user(i) will have a combined weight distribution for all assets (a) set at the previous time (t−1):

W(t,a,t−1) (12)

The weight distribution defines the user estimated return(R) for the user between t−1 and t:

$${R}_{estimated} ( t , t ) = {\sum }_{a = 1}^{n ( t )} ( W ( t , a , t - 1 ) * r ( a , t ) ) \qquad ( 13 )$$

When users invest, they make a certain amount of cash available in their account. When rebalancing, this cash is transformed into a percentage of the index funds total value, and this percentage is added to the users account so that the growth of this investment is controlled by the users input. When rebalancing, each user(i) will have made deposits (can be zero) since previous rebalancing (t−1), that will be included in the user value at the new time(t):

dep(i,t) (14)

When users want to withdraw their index funds, they mark a percentage of their investment for withdrawal. When rebalancing, each user(i) will have made withdrawals (can be zero) since previous rebalancing (t−1), that will be excluded from the user value at the new time(t), this can be represented as a percentage of the total user value:

wdr(i,t)=F_{withdrawal}*IV(i,t−1) (15)

All this will define the new estimated users value(IV) for the user:

IV_{estimated}(i,t)=IV(i,t−1)*(1+R_{estimated}(i,t))+dep(i,t)−wdr(i,t) (16)

The new estimated distribution of assets(a) for the total index fund is calculated:

$${v}_{estimated} ( a , t ) = {\sum }_{t = 1}^{m ( t )} ( W ( t , a , t ) * {IV}_{estimated} ( t , t ) ) \qquad ( 17 )$$

The new estimated total value for the index fund is then:

$${TV}_{estimated} ( t ) = {\sum }_{a = 1}^{n ( t )} {v}_{estimated} ( a , t ) \qquad ( 18 )$$

Given the calculations above, the estimated transaction list of value changes (chng), can be sent to the broker/trading system at the time when the index fund is to be rebalanced:

chng_{estimated}(a,t)=v_{estimated}(a,t)−v(a,t−1) (19)

The estimated amount of each asset that needs to be traded, can be calculated based on the asset (close) price:

$${amnt}_{estimated} ( a , t ) = \frac{{chng}_{estimated}}{p ( a , t )} \qquad ( 20 )$$

This gives automatically the transaction list to be sent to the broker/trader solution to alter the composition of the index fund through trading.

Withdrawals must be followed up separately to control the liquidity when turning assets into cash. A separate trading list for the assets that will be traded into cash for withdrawals is calculated.

Each user's (i) withdrawal can be represented as a distribution of assets(a) from the users account:

wdr(i,a,t)=P_{withdrawal}*IV(i,t−1)*W(t,a,t−1) (21)

The estimated amount of each asset that needs to be traded of each asset(a) for each user(i), can be calculated based on the asset (close) price:

$${wdramnt}_{estimated} ( t , a , t ) \text{?} = \frac{{wdr}_{estimated} ( t , a , t )}{p ( a , t )} \\ \text{?} \text{indicates text missing or illegible when filed} \qquad ( 22 )$$

To get the total withdrawal list, the summation of all users is:

$${wdramt}_{estimated} ( a , t ) = {\sum }_{t = 1}^{m ( t )} {wdramt}_{estimated} ( t , a , t ) \qquad ( 23 )$$

Accounting

When the adjustments needed for every asset is processed by the broker/trader solution there will probably be a small deviation between the actual traded price and amount, and the closing price and calculated amounts used in the calculations above. For each asset(a) there is a price(p) and the traded amount(amnt) for the actual trading at any given time(t):

P_{actual}(a,t) amnt_{actual}(a,t) (24)

The index funds total value will still be calculated from the closing price(p). However, it is necessary to consider any deviations in the traded amount. The actual distribution of assets(a) for the total index fund after trading is:

v_{actual}(a,t)=v_{estimated}(a,t)−p(a,t)*(amnt_{estimated}(a,t)−amnt_{actual}(a,t) (25)

The total value for the index fund is then:

$${TV}_{actual} ( t ) = {\sum }_{a = 1}^{n ( t )} {v}_{actual} ( a , t ) \qquad ( 26 )$$

To control liquidity, it is important that withdrawals are paid based on the actual traded amounts and prices in case they differ from the estimated prices. To be able to manage this automatically the system will make a special list of all assets that have to be sold to get cash for withdrawals. After the processing, the actual numbers must be returned:

$${wdr}_{actual} ( i , t ) = {\sum }_{a = 1}^{n ( t )} ( {wdramnt}_{actual} ( i , a , t ) * {p}_{actual} ( a , t ) ) \qquad ( 27 )$$

This is the amount that will be transferred to the respective user's respective accounts.

According to an example of embodiment of the present invention, an automated user-controlled fund investment system, wherein respective users of the fund investment system has user defined fund investment profiles being recorded and updated in a back-end server system, wherein the investment system further comprises:
a mobile computer-based device configured with an investment system interface application program,
the back-end server system in communication with the mobile computer-based device is configured to respond to user interactions provided via the investment system interface application program,
a trading server system in communication with the back-end server system is configured to execute trading orders associated with responses of the back-end server system responding to respective user interactions from the configured investment system interface application program,
wherein the bac-end server system further is configured to receive network communicated notifications related to results of trading orders from the trading server system, and
at a selected time, t, the back-end server system is configured to rebalancing the fund and update associated results in respective user profiles and reporting results to respective investment system interface applications programs of respective mobile computer-based devices.

Further, the back-end server system may be configured to provide segmentation of assets of the fund into assets groups, wherein the grouping is according to at least a geographical region, and/or countries, and/or industrial sectors.

Further, a user may define at least one asset of one or more asset groups via the investment system interface application program.

Further, the investment system interface application program may be configured with a graphical interface comprising visual indicators representing respective asset groups.

Further, respective visual indicators may be displayed on a touch sensitive surface of a display in communication with the mobile computer-based device.

Further, respective visual indicators may comprise further selectable visual sub-indicators.

Further, a visual sub-indicator may be associated with a single company.

Further, respective visual indicators may be a configured computer model of a gliding physical potentiometer, wherein a user changeable position of a button associated with the configured computer model of the physical potentiometer indicates a user defined percentage change of exposure to the associated assets group.

Further, the investment system interface application program running in the mobile computer-based device may be configured with an application program interface (API) enabling a user to define and execute scripts automating control of respective investments.

Further, at least a first user of the system may be enabled to follow an investment performance of at least a second user of the system.

Further, respective user profiles may be configured with a default investment profile.

1. An automated user-controlled fund investment system wherein respective users of the fund investment system has user defined fund investment profiles being recorded and updated in a back-end server system, wherein the investment system further comprises:
a mobile computer-based device configured with an investment system interface application program enabling configuration of specific investment profiles,
the back-end server system in communication with the mobile computer-based device is configured to respond to user interactions provided via the investment system interface application program,
a trading server system in communication with the back-end server system is configured to execute trading orders associated with responses of the back-end server system responding to respective user interactions from the configured investment system interface application program from the back-end server,
wherein the bac-end server system further is configured to receive network communicated notifications related to results of trading orders from the trading server system, and submitting respective results to respective mobile devices, and
at a selected time, t, the back-end server system is configured to rebalancing the fund and update associated results in respective user profiles and reporting results to respective investment system interface application programs of respective mobile computer-based devices.

2. The system of claim 1, wherein the back-end server system is configured to provide segmentation of assets of the fund into assets groups, wherein the grouping is according to at least a geographical region, and/or countries, and/or industrial sectors.

3. The system of claim 2, wherein a user can define at least one asset of one or more asset groups via the investment system interface application program.

4. The system of claim 2,
wherein the investment system interface application program is configured with a graphical interface comprising visual indicators representing respective asset groups,
wherein respective visual indicators are displayed on a touch sensitive surface of a display in communication with the mobile computer-based device,
wherein respective visual indicators comprises further selectable visual sub-indicators,
wherein a visual sub-indicator is associated with a single company, and
wherein respective visual indicators are configured as a computer model of a gliding physical potentiometer, wherein a user changeable position of a button associated with the configured computer model of the physical potentiometer indicates a user defined percentage change of exposure to the associated assets group.

5-8. (canceled)

9. The system of claim 1, wherein the investment system interface application program running in the mobile computer-based device is configured with an application program interface (API) enabling a user to define scripts automating control of respective investments.

10. The system of claim 1, wherein at least a first user of the system is configured to follow an investment performance of at least a second user of the system.

11. The system of claim 1, wherein the fund is an index fund.

12. The system of claim 1, wherein respective user profiles are configured with a default investment profile.

13. A computer implemented method of user-controlled investments in a fund controlled by an automated fund investment system according to claim 1, wherein the fund is investing in assets groups comprising geographical regions, and/or countries, and our industrial sectors, wherein the computer implemented method comprises steps of:
deciding by a user an amount to invest in the fund,
activating a payment solution transferring the amount to an investment account in the user's name in the investment system,
calculating an estimated percentage of the total fund owned by the user after the transfer of the amount,
using the estimated percentage of the total fund of the user together with the percentage of each other user in the fund, and update the estimated percentage accordingly,
waiting until results of any trading with the respective user-amounts is finished, and rebalancing the fund,
calculating respective user's actual percentage of the fund based on the result of the trading and the rebalancing of the fund.

14. The method according to claim 13, further comprising steps of:
when users withdraw an amount from the fund, the respective users decide the amounts to withdraw,
calculating the respective users estimated percentage of the total fund after assets has been sold and rebalancing of the fund,
calculating the respective user's actual percentage of the fund,
updating the withdrawal with actual results from the trade,
transferring cash to the respective user's accounts.

15. The method according to claim 13, wherein rebalancing comprises at least steps of:
calculating total withdrawals from a user's individual withdrawals,
selling assets accordingly and put cash into respective user-accounts,
update a user's withdrawals with actual trading results, then
in an outer iterate loop for each asset group:
iterating in an inner loop for each user:
calculating a total percentage of the total fund for each user from a combination of asset group and user,
multiplying the percentage from the combination of the asset groups and user with the user's percentage of the total fund,
normalizing to one hundred percent to get the estimated share for the asset group in the total fund, then
iterating in an outer iteration loop for each asset the fund is invested:
iterating in an inner loop for each asset group the asset is part of:
combining the estimated shares of the asset groups with the percentage that the asset is of the total asset group, thereby finding the estimated holding,
normalizing to one hundred percent to get the estimated share of the asset in the total fund,
combining the estimated share of the asset with the fund's total value to get the estimated holding of the asset,
subtract the actual holding from the estimated holding to get the amount that needs to be traded,
send the amount to a broker or a trading system,
update the actual holding with the resulting trades form the broker or trading system.

16. The method according to claim 15, wherein the step of rebalancing is performed when a last one of respective stock exchanges and/or commodity exchanges the fund is trading with is closing.

17. The method according to claim 15, wherein the step of rebalancing is performed at a defined time t.

18. The method according to claim 15, wherein the step of rebalancing is performed on instructions from a system administrator.

19. The method according to any claim 13, wherein the fund is an index fund.
